(19) United States
(12) Patent Application Publication
(10) Pub. No.: US 2024/0282163 A1
(43) Pub. Date: Aug. 22, 2024

(54) MOBILE AUTOMATED DISPENSING MACHINE DEVICES AND METHODS

(71) Applicant: CAREFUSION 303, INC., San Diego, CA (US)

(72) Inventors: Dennis A. TRIBBLE, Ormond Beach, FL (US); Brendan BURGESS, Poway, CA (US)

(21) Appl. No.: 18/568,533

(22) PCT Filed: May 23, 2022
(86) PCT No.: PCT/US2022/030578

§ 371 Date: Dec. 8, 2023

Related U.S. Application Data
(60) Provisional application No. 63/216,251, filed on Jun. 29, 2021.

(51) Int. Cl. G07F 11/46; G07F 9/00; G07F 11/18; G07F 17/00

(52) U.S. Cl. CPC G07F 11/46; G07F 9/006; G07F 11/18; G07F 17/0092

(57) ABSTRACT

Robotic automated dispensing systems that include a dispensing cabinet, a location tracking device configured to transmit information identifying a current location of the dispensing cabinet, a drive unit, and one or more movement elements in dynamic connection with the drive unit. In a first mode, at least one of the one or more movement elements is engaged to move via a first force provided by the drive unit. In a second mode, at least one of the one or more movement elements is disengaged from the drive unit to move via a second force. Mobile automated dispensing systems and robotic delivery devices are also provided.

### CROSS REFERENCE TO RELATED APPLICATIONS

This is a U.S. national stage application of International Patent Application No. PCT/US2022/030578, entitled “MOBILE AUTOMATED DISPENSING MACHINE DEVICES AND METHODS,” filed May 23, 2022, which claims the benefit of and priority to U.S. provisional patent application 63/216,251, entitled “MOBILE AUTOMATED DISPENSING MACHINE DEVICES AND METHODS,” filed Jun. 29, 2021, all of which are incorporated herein by reference in their entireties.

### TECHNICAL FIELD

The present disclosure generally relates to mobile automated dispensing machines, in particular automated devices and methods for refilling an automated dispensing machine or portion for refilling.

### BACKGROUND

Clinical environments typically feature two types of automated dispensing cabinets. A majority tend to be fixed automated dispensing cabinets. Fixed cabinets are typically associated with specific care areas (e.g., wards). The cabinets are accessed nearly all day long by a variety of users as clinicians care for their patients. Moving a fixed cabinet typically requires substantial effort and as such, once installed, a fixed cabinet is stationary and will remain at the installation location. One example of a fixed cabinet is a BD PYXIS™ MEDSTATION™ ES by Becton, Dickinson and Company of Franklin Lakes, NJ.

The other type of automated dispensing cabinets are mobile automated dispensing cabinets. Mobile cabinets may be located in medical treatment areas, such as operating rooms and surgical suites. Unlike fixed cabinets, the mobile cabinets are typically in use by a single user (such as an anesthesiologist) during a patient care procedure and then are left idle. These procedures often start early in the morning, can be lengthy, and can occur in rapid sequence, leaving little time during their operating day for being refilled. As a result, these cabinets are typically refilled after the procedural areas are closed. Furthermore, unlike fixed cabinets, a mobile cabinet may be positioned for use in a manner that suits the individual user and/or arbitrarily moved to different rooms, suites, or other locations within the clinical environment. One example of a mobile cabinet is a BD PYXIS™ ANESTHESIA STATION ES by Becton, Dickinson and Company of Franklin Lakes, NJ.

Currently, restocking requires that pharmacy personnel prepare and deliver replacement inventory to a mobile cabinet. Typically, only very large hospitals have sufficient pharmacy staff capable of traveling the clinical environment to refill mobile cabinets at any time of day or night. Furthermore, the location of the mobile cabinets may be undetermined when a staff member leaves the pharmacy for refill.

For these reasons, it is desirable to provide automated systems for transferring all or part of a mobile automated dispensing cabinet to or from a pharmacy, so that mobile automated dispensing cabinets can be refilled or restocked by travelling to the pharmacy rather than having the pharmacy personnel travel to the mobile cabinet.

### BRIEF DESCRIPTION OF THE DRAWINGS

The accompanying drawings, which are included to provide further understanding of the disclosure and are incorporated in and constitute a part of this specification, illustrate embodiments of the disclosure and together with the description serve to explain the principles of the disclosure.

FIG. 1 depicts a typical dispensing cabinet configuration.

FIG. 2 depicts another typical dispensing cabinet configuration.

FIG. 3 depicts a perspective view of a robotic automated dispensing system, according to aspects of the disclosure.

FIG. 4 depicts a perspective view of a mobile automated dispensing system, according to aspects of the disclosure.

FIG. 5 depicts a perspective view of a robotic delivery device, according to aspects of the disclosure.

FIG. 6 depicts a perspective view of a robotic automated dispensing system in a disengaged from self-driving configuration, according to aspects of the disclosure.

FIG. 7 depicts a perspective view of the robotic automated dispensing system of FIG. 6 in a self-driving configuration, according to aspects of the disclosure.

FIG. 8 depicts a perspective view of a robotic automated dispensing system, according to aspects of the disclosure.

FIG. 9 depicts a perspective view of a removable drawer section of the robotic automated dispensing system of FIG. 8, according to aspects of the disclosure.

FIG. 10 depicts a perspective view of a mobile shell of the robotic automated dispensing system of FIG. 8, according to aspects of the disclosure.

FIG. 11 depicts a perspective view of a robotic automated dispensing system, according to aspects of the disclosure.

FIG. 12 depicts a perspective view of a robotic automated dispensing system, according to aspects of the disclosure.

FIG. 13 depicts a perspective view of a removable drawer section of the robotic automated dispensing system of FIG. 12, according to aspects of the disclosure.

FIG. 14 depicts a side view of the removable drawer section of FIG. 13, according to aspects of the disclosure.

FIG. 15 depicts a perspective view of the robotic automated dispensing system of FIG. 12 with the removable drawer section removed, according to aspects of the disclosure.

FIG. 16 depicts a perspective view of a robotic automated dispensing system, according to aspects of the disclosure.

FIG. 17 depicts a perspective view of a mobile shell of the robotic automated dispensing system of FIG. 16, according to aspects of the disclosure.

FIG. 18 depicts a perspective view of the robotic automated dispensing system of FIG. 16 with the top removed, according to aspects of the disclosure.

FIG. 19 depicts a block diagram illustrating an example computer system with which the automated dispensing machines of any of FIGS. 3-18 can be implemented.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions are provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the appended claims. Various aspects of the subject technology will now be disclosed according to particular but non-limiting examples. Various embodiments described in the present disclosure may be carried out in different ways and variations, and in accordance with a desired application or implementation.

Current inventory management for mobile automated dispensing cabinets requires pharmacy workers to run reports describing the current state of inventory in a cabinet, pull replacement supplies as needed, travel to the cabinet location with those replacement supplies and refill the cabinet in place. For procedural areas served by these mobile automated dispensing cabinets, a typical time for refilling occurs when the procedural area is closed, and the cabinets are not in use. As previously described, these times occur late at night when the pharmacy staffing does not permit staff members to be absent from the pharmacy for prolonged periods of time to perform refilling functions.

While the reduced pharmacy staffing is potentially adequate to perform the filling, it is not adequate to permit the staff to be missing from the pharmacy during these hours (e.g., finding and filling mobile cabinets throughout the medical facility). Even very large hospitals with around the clock pharmacy staffing may not have sufficient staff to handle pharmacy orders at all times and to travel throughout the hospital refilling cabinets, whether fixed or mobile.

A typical attempt to overcome these issues is automated tugs that can be configured to perform deliveries to various locations from which humans may remove items being delivered. While use of such tugs may be able to bring replacement inventories to an area where an automated dispensing cabinet is located, a pharmacy person would still be required to be physically present to perform the replacement. For example, nurses lack permission and the inclination to perform these tasks pharmacy tasks. Further, these automated dispensing cabinets are typically fastened permanently in place and connected to a variety of power and network cables, which would have to be manipulated in order to uncouple or remove the cabinet.

Also, the software in typical automated dispensing cabinets is configured to expect the cabinet to be fixed in place, thus removing the cabinet causes problems with the software and with maintaining continuity of the transactional data surrounding use of such a cabinet. Further, for automated dispensing cabinets in procedural areas may be used only in certain hours of the day, or certain days of the week, there are potential medication security issues associated with them being in locations where they are not routinely monitored by personnel for long periods of time, leaving them open to theft and damage.

According to aspects of the disclosure, an automated system addresses this problem by permitting the staff to remain in the pharmacy and intermix the refill process with other competing demands within the pharmacy, such as filling on demand orders.

In aspects of the disclosure, an automated system is provided to cause at least a portion of a mobile automated dispensing cabinet to be transferred to and/or from a central pharmacy for refilling/restocking. For example, an anesthesia station in an operating room or surgical suite becomes depleted and needs to be refilled after one or more surgical procedures occur. As another example, the anesthesia station may need to be stocked differently after one or more particular surgical procedures in anticipation of upcoming different surgical procedures. In aspects of the disclosure, any type of mobile automated dispensing system may be included, such as pill dispensing machines, for example.

In aspects of the disclosure, a mobile automated dispensing cabinet may disconnect itself from its current location (e.g., a surgical suite), transfer itself to a pharmacy and connect itself to a location at the pharmacy for filling. The cabinet may then return itself to its home location (e.g., the same surgical suite) when filled and checked.

In aspects of the disclosure, an additional cabinet may be filled to replace a designated cabinet already disposed in a desired location. Here, the additional cabinet travels to the designated cabinet location, commands the designated cabinet to disconnect and remove itself, and then replaces the designated cabinet. The designated cabinet then travels to the pharmacy to be repurposed (e.g., to refill another cabinet).

In aspects of the disclosure, a robotic delivery device may travel to and capture a designated cabinet or portion thereof, disconnect it from its current location, bring it to the pharmacy and dock it for refilling. Once refilled, the delivery device may capture and disconnect the refilled designated cabinet or portion thereof and return it to its original location.

In aspects of the disclosure, a robotic delivery device may bring a filled replacement mobile cabinet to a location where a mobile cabinet is already in the clinical environment, place the replacement mobile cabinet into service, capture the in-service mobile cabinet and return the in-service cabinet to the pharmacy for refilling or re-purposing. Upon placement, the system may include activate the replacement mobile cabinet to indicate it is “in-service” and available for dispensing. Upon retrieval of the in-service cabinet, the system may deactivate the in-service cabinet to indicate it is no longer “in-service”. Once taken out of service, a mobile cabinet may limit features or functions available. For example, an out of service cabinet may prevent access to all or portions of pockets in the cabinet containing medical items.

In aspects of the disclosure, a robotic delivery device may remove one or more portions of a designated automated dispensing cabinet (e.g., removable drawers, removable compartments), return the removed portions of the designated cabinet to the pharmacy for checking and refilling, transfer the refilled portions back to the designated cabinet and re-installing the refilled portions into the designated cabinet.

In aspects of the disclosure, a robotic delivery device may carry a refilled storage portion (e.g., drawer, compartment) of a mobile automated dispensing cabinet to a designated cabinet, remove the complementary storage portion (e.g., empty or depleted drawer, compartment) from the designated cabinet, install the refilled storage portion into the designated cabinet and bring the removed storage portion back to the pharmacy for storage and/or refilling.

In aspects of the disclosure, a floor-mounted or wall-mounted connection apparatus may provide power and network connectivity to a mobile automated dispensing cabinet, as well as a cabinet location identity. Such a cabinet may be disconnected from the apparatus to permit the cabinet to motor itself or to be dragged to another location (e.g., to be refilled).

In aspects of the disclosure, a mobile automated dispensing cabinet may be configured with the capacity for robotic movement that can disconnect itself from such a connection apparatus, travel to a refill location, be refilled, and then travel back to its original location.

In aspects of the disclosure, a mobile automated dispensing cabinet may be configured to be movable and that can disconnect itself from a connection apparatus when commanded by a robotic device, be captured by the robotic device, be transported and delivered to the pharmacy for refill, be transported back into its original location and to reconnect itself to the connection apparatus. In aspects of the disclosure, a mobile automated dispensing cabinet may include specific sections (e.g., drawers, drawer units, compartments) that are configured to be mechanically removable by a robotic device.

In aspects of the disclosure, a robotic device may be any of configured to capture the above described automated dispensing cabinet for the above described workflow, configured to capture a filled automated dispensing cabinet and exchange it for a used (e.g., depleted) automated dispensing cabinet in a particular location, and configured to remove a storage section (e.g., drawer, compartment) from a cabinet and either refilled in the pharmacy and replaced, or simply replaced with a pre-filled replacement storage section with desired contents.

In aspects of the disclosure, a refilling station or stations may be provided to which a cabinet or portion of a cabinet may be connected for refilling without losing its cabinet identity. This will capture the refilling identity and location whether the cabinet or cabinet portion was returned to its original location or used to replace another cabinet/cabinet portion that needed to be refilled.

In aspects of the disclosure, an automated system may capture transactional data for a device location as well as a serialized automated dispensing cabinet device so that transactional data integrity for the location and device transactional data are not lost. Transactional data may be captured and presented in a way that it could be viewed either as transactional data from a cabinet location or transactional data associated with a particular device.

In aspects of the disclosure, a mobile automated dispensing cabinet and/or a robotic device may move itself to the pharmacy at some pre-determined time. For example, a self-movable anesthesia station may move itself to the pharmacy after the last scheduled surgery for the day is completed. As another example, a self-movable anesthesia station may move itself to the pharmacy upon command from someone either in the pharmacy or in the surgery/procedural suite.

According to aspects of the disclosure, there may be a defined cabinet location which is the place where an identified connection apparatus is installed. Any automated dispensing cabinet that is attached to that connection apparatus becomes the cabinet intended to be there. In aspects of the disclosure, the automated system may be self-aligning where there are guides on the connection apparatus and on the automated dispensing cabinet that ensure proper attachment.

In aspects of the disclosure, when the connection apparatus and the automated dispensing cabinet are not attached, there may be protective devices to ensure that the connections of either of the connection apparatus and the automated dispensing cabinet are not damaged when not in use.

In aspects of the disclosure, the connection apparatus provides power and network connectivity for any device attached to it. When not attached to a connection apparatus, an automated dispensing cabinet may be able to remain powered for at least 60 minutes for motion and to preserve data content, though it may otherwise be locked from user input or manipulation.

In aspects of the disclosure, when a cabinet is attached to a connection apparatus, the server managing the system of automated dispensing cabinets may update its understanding of what cabinet is now at that location, and what medications are available from that location. This may include notifying a hospital information system (e.g., sometimes referred to as an electronic medical record system) what is currently available from that location.

In aspects of the disclosure, an automated dispensing cabinet may have sections that are removable, for which the system may be configured to prevent unauthorized removal of these sections. Disconnection of a removable section from a cabinet may update the server's awareness of what is in the cabinet and notify a hospital information system of that change as needed. Connection of the same or different section to an automated dispensing cabinet may update the server's awareness of what is in the cabinet and where it is located, with updates back to the hospital information system where appropriate.

In aspects of the disclosure, connection of a mobile automated dispensing cabinet to a refill location may cause the server to be updated with the cabinet location and state. Refill transactions may be associated with the transactional history of the location. Various refill activities may be associated with the cabinet with the location being the pharmacy refill location.

In aspects of the disclosure, a mobile cabinet refill sequence may maintain transactions with the cabinet that document disconnection from a particular location, moving to the pharmacy, being attached at the pharmacy, being detached from the pharmacy and sent to a specific location, and attachment at that location. A detachable section refill sequence may maintain transactions with the section that document the movement of the section as described above in relation to the cabinet.

In aspects of the disclosure, physical stations to which a movable cart can attach may be located both in an area of service (e.g., an operating room) and in an area for refill (e.g., pharmacy). In aspects of the disclosure, there may be a mechanism within a movable station to detect that it is connected and to permit normal use of the station. Similarly, there may be a mechanism within a movable station to detect that it is not connected and to prohibit normal use of the station (e.g., prevent access to certain compartments or containers). In aspects of the disclosure, a portion of an automated dispensing cabinet may be disconnected, removed and transported to a filling location.

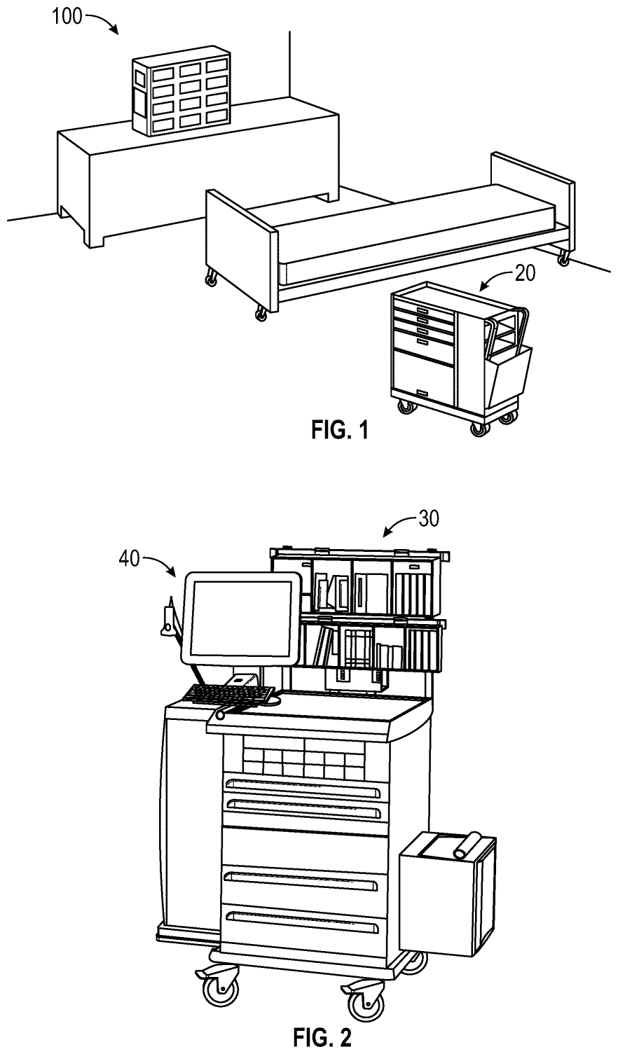

FIGS. 1 and 2 depict typical dispensing cabinets and systems. For example, in FIG. 1 a medicine dispensing cabinet 10 is affixed to a room, such as a counter as shown, a patient's bed, a table near the patient, or any item which is fixed. A medical cart 20 is movable by hand within the room or between multiple rooms. The cabinet 10 and cart 20 each can be used to store and dispense supplies and medications.

As shown in FIG. 2, a mobile dispensing cabinet 30 (e.g., anesthetist cart) has wheels and is movable by hand within an operating room, for example. The mobile dispensing cabinet 30 is also hand movable to a hospital pharmacy where it can be restocked and brought back to the operating room. Here, authentication and access is provided through interface devices 40 (e.g., monitor, scanner and keyboard).

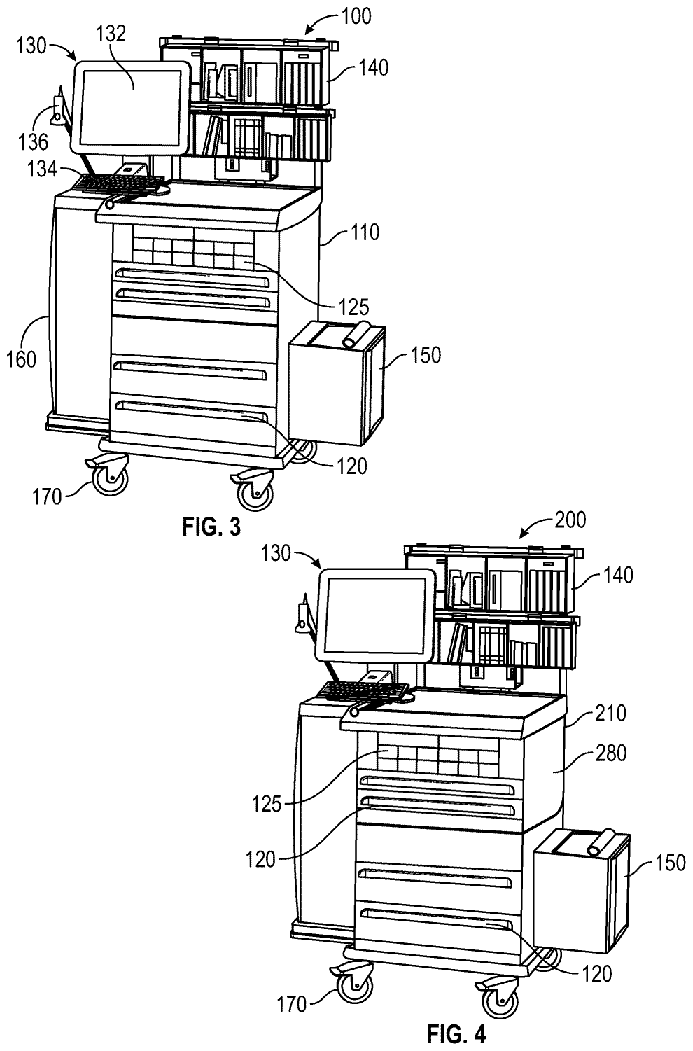

According to aspects of the disclosure, a robotic automated dispensing system 100 is shown in FIG. 3. Robotic automated dispensing system 100 is configured for robotic movement of the entire system to and from a pharmacy. For example, robotic automated dispensing system 100 may be an anesthesia station that travels between an operating suite and a pharmacy of a medical center (e.g., hospital, outpatient surgical clinic) so that the robotic automated dispensing system 100 is properly stocked for upcoming surgical procedures.

The robotic automated dispensing system 100 may include a mobile dispensing cabinet 110 with multiple securable drawers 120 and compartments 125. An interface station 130 may include a display 132 and input devices such as a keyboard 134 and a scanner 136. Supply cabinets 140 may be attached to the dispensing cabinet 110, the supply cabinets 140 configured to store supplies (e.g., anesthesia supplies) that may or may not be required to be secured. Thus, the supply cabinets 140 may be either unlockable or lockable, for example.

The robotic automated dispensing system 100 may also include a waste device 150 for securely receiving used supplies (e.g., used hypodermics). A drive unit 160 and movement elements (e.g., wheels, tracks) 170 provide movement functions to the robotic automated dispensing system 100. For example, the drive unit 160 may include any of a motor or drive linked to the movement elements 170, a steering mechanism for controlling the direction of movement, and one or more location tracking devices (e.g., sensors or geolocation devices) to identify the current position of the robotic automated dispensing system 100 and to guide the robotic automated dispensing system 100 to a desired destination (e.g., surgical suite, pharmacy). In some implementations, the location tracking device may transmit information identifying a current location of the associated cabinet. The drive unit 160 may also include docking connectors (e.g., power connector, communication connector), as well as an energy storage device (e.g., a battery).

In use, the robotic automated dispensing system 100 may be configured to interact with building elevators for transit to and from the operating room or pharmacy. For example, the system 100 may include a wireless emitter configured to transmit signals to an elevator receiver. A signal may indicate the floor where the pharmacy is located. A signal may include an indicator that the request is transmitted from an autonomous actor (e.g., the system 100). In some implementations, the signal may include an identifier of the system 100. In this way, the signal may be used to track the system's location. The robotic automated dispensing system 100 may also be configured to position itself in a convenient/desired place during use (e.g., positioned next to anesthesiologist during surgery) and to move itself back to a docking station when not in use. For example, a docking station in a surgical suite may provide a starting point for the robotic automated dispensing system 100 trip to the pharmacy, as well as a finishing place to which the robotic automated dispensing system 100 returns after being refilled or properly stocked at the pharmacy.

Also in use, the robotic automated dispensing system 100 may use a self-contained energy source or battery to provide enough mobile power to navigate to a docking station in the pharmacy and to navigate back to a docking station in an operating room. The energy source may also provide the necessary power to use the robotic automated dispensing system 100 while not connected to a docking station. For example, when the robotic automated dispensing system 100 is positioned next to the anesthesiologist during surgery or positioned in the pharmacy other than at the pharmacy docking station. While connected to either of the pharmacy or operating room docking stations, the robotic automated dispensing system 100 may pull power through the docking connectors for use of the robotic automated dispensing system 100 and/or for charging the energy device on the robotic automated dispensing system 100. When the appropriate time to transit to the pharmacy arrives, the system 100 may determine a quantity of battery power available and compare the available amount to a minimum threshold amount needed to transit to the pharmacy or other refill location. The threshold may be dynamically generated based on the current location of the system 100 taking into account either or both of lateral and vertical distance between the system 100 and the refill location. If the amount of available power is not sufficient to reach the refill location, the system 100 may defer transit until the level reaches the threshold amount. When deferring, the system 100 may transmit a message to indicate the status or reason for delay.

The robotic automated dispensing system 100 may include a locking mechanism or closure mechanism that blocks access to the drawers/compartments of the cabinet 110 during transit, so that contents of the robotic automated dispensing system 100 cannot be removed by unauthorized personnel. In addition, the robotic automated dispensing system 100 may be configured to remember its identity when disconnected from communications (e.g., intranet) and stationary power provided by the docking station.

Also in use, transactional data may include activities both in the pharmacy and back in the operating room where the transactions identify the location of the robotic automated dispensing system 100.

The robotic automated dispensing system 100 may be configured to have a number of states. For example, the robotic automated dispensing system 100 may be in an idle state in an operating room (e.g., no active surgical case occurring at that time), or in an in use state in the operating room (e.g., during a currently active surgical case). A transit to pharmacy state may indicate the robotic automated dispensing system 100 is on its way to the pharmacy. Here, the robotic automated dispensing system 100 may provide periodic or continuous geolocation updates to allow for users to ascertain where the system is during transit.

Another state may be in pharmacy awaiting refill. Here, the robotic automated dispensing system 100 may be docked at the pharmacy docking station or parked in other pharmacy storage locations. The robotic automated dispensing system 100 may also be in a being filled state, thus indicating it is being actively filled/restocked at the pharmacy. During this state, transactions for each medication management activity may be provided. Another state may be in pharmacy awaiting filling check. For example, the pharmacist may be required to check the refilled items against the contents of the robotic automated dispensing system 100. Yet another state may be that the robotic automated dispensing system 100 is in transit back to the operating room, again providing periodic or continuous geolocation updates to allow for users to ascertain where the system is during transit.

As shown in FIG. 4, a mobile automated dispensing system 200 may have many features in common with robotic automated dispensing system 100. Here, mobile automated dispensing system 200 may have a cabinet 210 that includes removable sections 280. For example, a removable section 280 may include any number of drawers 120 and/or compartments 125.

In aspects of the disclosure, the mobile automated dispensing system 200 may have any or all of the features of robotic automated dispensing system 100, including being self-movable. In this case, the mobile automated dispensing system 200 may travel to the pharmacy and the pharmacist may only have to remove section 280 and insert a replacement section 280 that is already stocked and checked/verified. For example, the mobile automated dispensing system 200 could travel to the pharmacy upon completion of a surgical procedure, have a replacement section 280 installed by the pharmacist and then travel back while the operating room is being prepped for the next surgery.

The cabinet 210 may include a wheel assembly attached to the dispensing cabinet. The wheel assembly may be adapted to move the dispensing cabinet (e.g., roll). The cabinet 210 may include one or more removable sections 280. At least one of the removable sections 280 includes a pocket or other container adapted to securely contain a medical item. The removable section 280 may include a data store (e.g., memory) to retain information about the section, a state of the section, items stored in the section, or the like.

The mobile automated dispensing system 200 may include a location tracking device. The location tracking device may transmit (e.g., periodically) information identifying a current location of the cabinet 210. The information identifying a current location may include coordinate, global positioning coordinates, image data, network address data, locator beacon data, wireless signal data (e.g., wireless way point markers), or the like. In some implementations, the location tracking device is integrated in or with the cabinet 210. In some implementations, the location tracking device is external to the cabinet 210 and configured to transmit location data detected through observation of the cabinet 210.

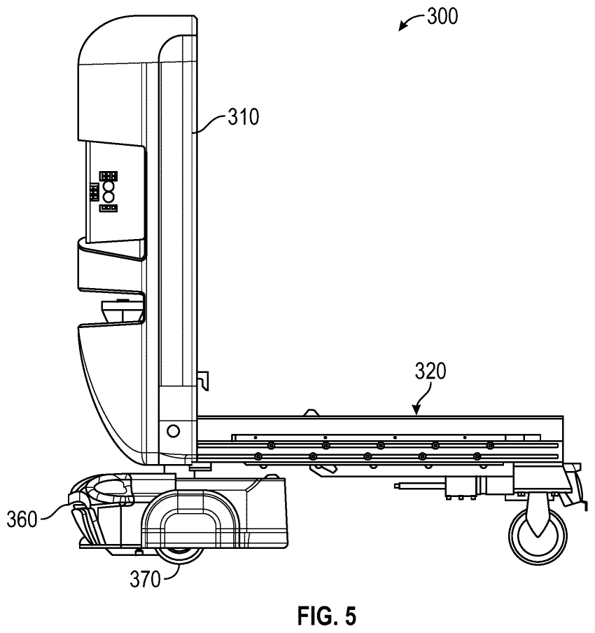

In aspects of the disclosure, the mobile automated dispensing system 200 may be stationary or moveable by hand only. In this case, the mobile automated dispensing system 200 would not include drive mechanisms or other elements required for self-driving. Here, the desired removable section 280 may be unlocked and removed, such as by a robotic delivery device 300 as shown in FIG. 5. For example, the removable section 280 may be released from the mobile automated dispensing system 200 by a special key that only the robotic delivery device 300 has.

In use, the robotic delivery device 300 may travel to the appropriate mobile automated dispensing system 200, unlock the designated removable section 280 with the special key and remove the removable section 280 from the mobile automated dispensing system 200. The robotic delivery device 300 may then insert a replacement section 280 that was filled at the pharmacy and transported with the robotic delivery device 300. Removable sections 280 may be serialized and have radio frequency identification (RFID) tags that uniquely identify each section 280, as well as track the position of the removable section 280 throughout the hospital. The removable sections 280 may also be configured to sound an alarm if someone tries to remove it from the building (e.g., hospital).

The mobile automated dispensing system 200 may be configured to recompute and restate its inventory based on the new removable section 280 that has been installed. Here, there may be transactional data to document the exchange. For example, transactional data may follow the removable section 280 rather than the mobile automated dispensing system 200. Thus, the transactional data knows where the removable section 280 is located (e.g., in a mobile automated dispensing system 200, in a pharmacy refill docking station) when the transactions occur.

In aspects of the disclosure, an ability is provided to query and report on the transactional data associated with a particular removable section 280 irrespective of where it has been or where it is currently located. For example, querying transactional data for the mobile automated dispensing system 200 may show only the transactions that occurred while at a particular mobile automated dispensing system 200, while querying transactional data for a removable section 280 may capture all relevant transactional data.

In aspects of the disclosure, chain-of-custody information about the removable section 280 and its contents may be provided. For example, the pharmacy may include automation to receive returning the removable sections 280 and to acknowledge receipt from a particular robotic delivery device 300.

The removable section 280 may be configured to have a number of states. For example, the removable section 280 may be in a use state where it knows the automated dispensing system 200 identification (ID) in which it is disposed. The removable section 280 may have an in-transit state where it knows the robotic delivery device 300 ID that is transporting it. In another state, the removable section 280 may be in a refill state. Here, the removable section 280 knows its location while awaiting refill and may be stored in such a way that nobody can access its contents.

Another state may be that the removable section 280 is being refilled, where the removable section 280 knows who (e.g., which pharmacist) is refilling it. Here, transactional refill data may include a docking station of some kind that permits access to pockets. The removable section 280 may also include a state of filled and awaiting checking, as well as a state of having been checked. Here again, the removable section 280 knows who (e.g., which pharmacist) checked it. Another state may be that the removable section 280 is awaiting use, where the removable section 280 knows its present location while awaiting use. Here again, a storage state may prohibit opening the removable section 280 for access to its contents.

In some implementations, the removable section 280 may include a data store to retain all or a portion of the information described. The data store may permit recording chain of custody of the removable section 280 from a cabinet, during dispense events while docked in the cabinet, prior to undocking from the cabinet, docking with a mobile drive unit, in transit by the mobile drive unit (or the cabinet proper), and arrival at the pharmacy.

FIG. 5 shows the robotic delivery device 300 that includes a housing 310 and a transport bed 320 configured to support any of entire automated dispensing system 200 and one or more removable sections 280. A drive unit 360 and wheels 370 provide movement functions to the robotic delivery device 300. For example, the drive unit 360 may include any of a motor or drive linked to powered wheels 370, a steering mechanism for controlling the direction of movement and sensors or geolocation devices to both identify the current position of the robotic delivery device 300 and to guide the robotic delivery device 300 to a desired destination (e.g., surgical suite, pharmacy).

In use, the robotic delivery device 300 may be configured to have any of the states discussed above, either in relation to itself (e.g., location of the robotic delivery device 300) or in relation to the device it is transporting (e.g., automated dispensing system 200, removable section 280).

Aspects herein have generally described transporting all or a portion of a mobile dispenser from a point of dispense to a refill location. In some implementations, the transportation may be from a first dispensing location to a second dispensing location. For example, if a procedure is changed from a first room to a second room, the features described may be used to cause the system 100 or device 300 to transfer supplies from the first room to the second room.

The devices described may be used to implement an automated refilling process. The process may include receiving cabinet location information for a mobile dispensing cabinet. The cabinet location information may identify a current location of the mobile dispensing cabinet. The process may include determining device location information identifying a current location of a robotic delivery device that will move at least a portion of the mobile dispensing cabinet. The process may include activating a drive unit to move the robotic delivery device toward the dispensing cabinet. The activation may be based at least in part on the device location information and the device location information. For example, the duration and direction to activate a motor may be identified using the location information.

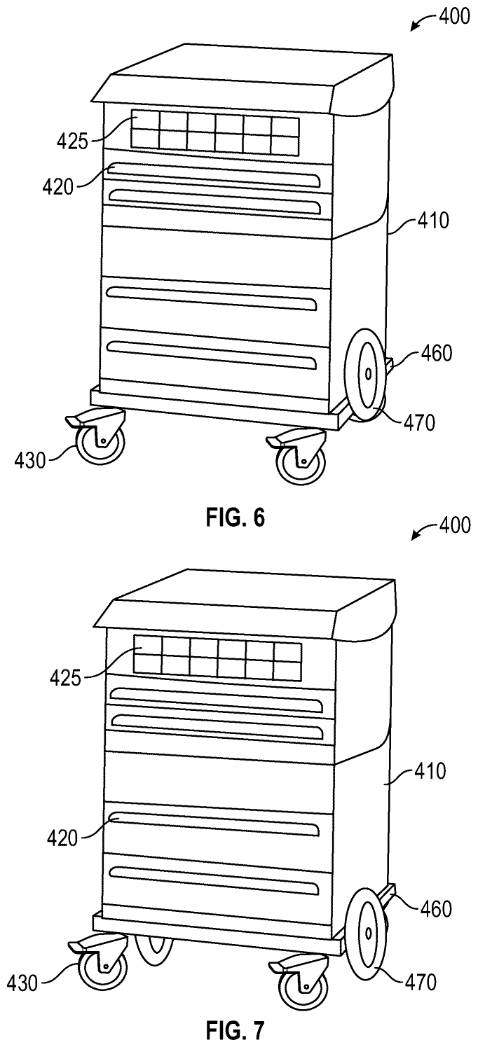

According to aspects of the disclosure, a robotic automated dispensing system 400 is shown in FIGS. 6 and 7. Robotic automated dispensing system 400 is configured for robotic movement of the entire system to and from a pharmacy. For example, robotic automated dispensing system 400 may be an anesthesia station that travels between an operating suite and a pharmacy of a medical center (e.g., hospital, outpatient surgical clinic) so that the robotic automated dispensing system 400 is properly stocked for upcoming surgical procedures.

The robotic automated dispensing system 400 may include a mobile dispensing cabinet 410 with multiple securable drawers 420 and/or compartments 425. Movement elements 430 (e.g., wheels) allow for the robotic automated dispensing system 400 to be moved around and/or positioned by hand. For example, the robotic automated dispensing system 400 may be pushed by a nurse in close to an anesthesiologist positioned by a patient on an operating table during a surgery and then pushed to a docking position along a wall after the anesthesiologist role in the surgery is done. Here, the movement elements 430 are un-powered wheels that can be freely moved by pushing or pulling the robotic automated dispensing system 400. In aspects of the disclosure, at least one of the movement elements 430 may be lockable or securable in order to hold the robotic automated dispensing system 400 in position.

A drive unit 460 and self-movement elements (e.g., motorized wheels/tracks) 470 provide self-movement functions to the robotic automated dispensing system 400. For example, the drive unit 460 may include any of a motor or drive linked to the self-movement elements 470, a steering mechanism for controlling the direction of movement, and one or more location tracking devices (e.g., sensors or geolocation devices) to identify the current position of the robotic automated dispensing system 400 and to guide the robotic automated dispensing system 400 to a desired destination (e.g., surgical suite, pharmacy). In some implementations, the location tracking device may transmit information identifying a current location of the associated cabinet. The drive unit 460 may also include docking connectors (e.g., power connector, communication connector), as well as an energy storage device (e.g., a battery).

In use, the robotic automated dispensing system 400 may have any of the features and/or functions described above, such as for the robotic automated dispensing system 100, for example. In aspects of the disclosure, the self-movement elements 470 may be configured to retract or lift into a storage position so that only the movement elements 430 are in contact with the floor. Here, the robotic automated dispensing system 400 can be pushed or pulled by a medical staff member to the desired position within the room. The self-movement elements 470 may also be configured to extend down into a drive position so that the self-movement elements 470 and the movement elements 430 are in contact with the floor. Here, the robotic automated dispensing system 400 can be moved or driven to the desired location (e.g., from the operating suite to the pharmacy) by the self-movement elements 470 via the drive unit 460. For example, with two self-movement elements 470 at opposing sides of the cabinet 410, the robotic automated dispensing system 400 be made to turn and navigate by holding one self-movement element 470 still while the other self-movement element 470 is moved.

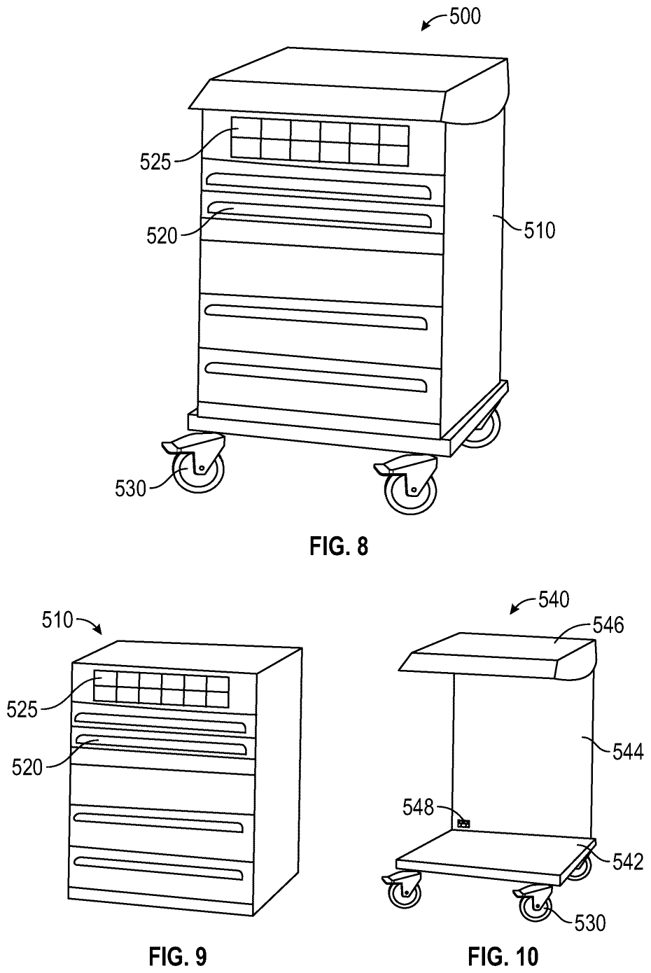

According to aspects of the disclosure, a robotic automated dispensing system 500 is shown in FIGS. 8 to 10. Robotic automated dispensing system 500 may be configured for robotic movement of only a removable dispensing cabinet 510 to and from a pharmacy. For example, robotic automated dispensing system 500 may be an anesthesia station, where the removable dispensing cabinet 510 travels between an operating suite and a pharmacy of a medical center (e.g., hospital, outpatient surgical clinic) via a robotic device (e.g., robotic delivery device 300) so that the robotic automated dispensing system 500 is properly stocked for upcoming surgical procedures.

The robotic automated dispensing system 500 may include the removable dispensing cabinet 510 with multiple securable drawers 520 and/or compartments 525. A mobile shell 540 may include a base 542, a back wall 544, a top surface 546, a connection point 548 (e.g., for power and/or data) and movement elements 530 (e.g., wheels).

Movement elements 530 (e.g., wheels) allow for the robotic automated dispensing system 500 to be moved around and/or positioned by hand. For example, the robotic automated dispensing system 500 may be pushed by a nurse in close to an anesthesiologist positioned by a patient on an operating table during a surgery and then pushed to a docking position along a wall after the anesthesiologist role in the surgery is done. Here, the movement elements 530 are un-powered wheels that can be freely moved by pushing or pulling the robotic automated dispensing system 500. In aspects of the disclosure, at least one of the movement elements 530 may be lockable or securable in order to hold the robotic automated dispensing system 500 in position.

In use, the robotic automated dispensing system 500 shown in FIG. 8 may be engaged by a robotic delivery device 300, which may remove and transport the removable dispensing cabinet 510 to the pharmacy to be restocked, leaving the mobile shell 540 in position in the original location (e.g., operating suite). Once the removable dispensing cabinet 510 is restocked by the pharmacy, the same or different robotic delivery device 300 may retrieve the restocked removable dispensing cabinet 510 and return it to the mobile shell 540 that it was removed from, or to a different mobile shell 540, for example.

For example, the robotic delivery device 300 may scan a barcode or other identifying information, which may be located in the connection point 548 of the mobile shell 540 to identify the mobile shell 540 intended to receive the removable dispensing cabinet 510. The robotic delivery device 300 may then insert the removable dispensing cabinet 510 into the mobile shell 540, where a power/communications connection may be established between the removable dispensing cabinet 510 (e.g., a connection port on the cabinet) and the connection point 548.

In aspects of the disclosure, any suitable mounting and/or guide structures (e.g., skids) may be provided on the removable dispensing cabinet 510 and the mobile shell 540. In aspects of the disclosure, barcodes or other identifying information may be disposed on the removable dispensing cabinet 510, individual drawers 520 and compartments 525 and/or any location of the mobile shell 540. In aspects of the disclosure, the robotic automated dispensing system 500 may include a self-moving device (e.g., drive unit 460 and self-movement elements 470), allowing the robotic automated dispensing system 500 to be self-driven as well.

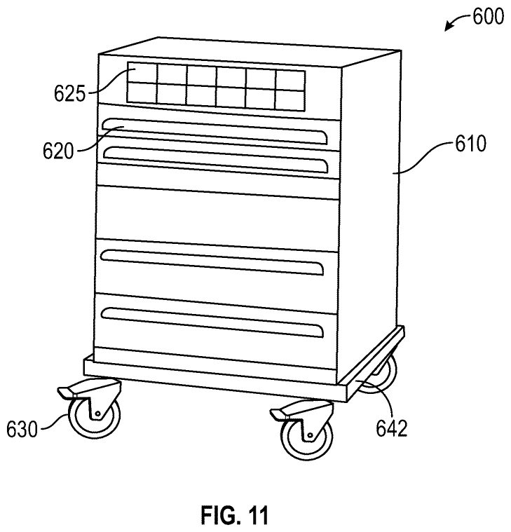

As shown in FIG. 11, a robotic automated dispensing system 600 may include a removable dispensing cabinet 610 with multiple securable drawers 620 and/or compartments 625, a base 642 and movement elements 630 (e.g., wheels). The removable dispensing cabinet 610 may be configured to be mated with or docked with a docking section (e.g., back wall 544, top surface 546 and connection point 548).

In use, the robotic automated dispensing system 600 shown in FIG. 11 may be engaged by a robotic delivery device 300, which may remove and transport the removable dispensing cabinet 610 to the pharmacy to be restocked, leaving the docking section in position in the original location (e.g., operating suite). Once the removable dispensing cabinet 610 is restocked by the pharmacy, the same or different robotic delivery device 300 may retrieve the restocked removable dispensing cabinet 610 and return it to the docking station that it was removed from, or to a different docking station and/or standalone location, for example.

In aspects of the disclosure, any suitable mounting and/or guide structures (e.g., recesses, skids) may be provided on the removable dispensing cabinet 610 and the docking section. In aspects of the disclosure, barcodes or other identifying information may be disposed on the removable dispensing cabinet 610, individual drawers 620 and compartments 625 and/or any location of the docking section/station. In aspects of the disclosure, the robotic automated dispensing system 600 may include a self-moving device (e.g., drive unit 460 and self-movement elements 470), allowing the robotic automated dispensing system 600 to be self-driven as well.

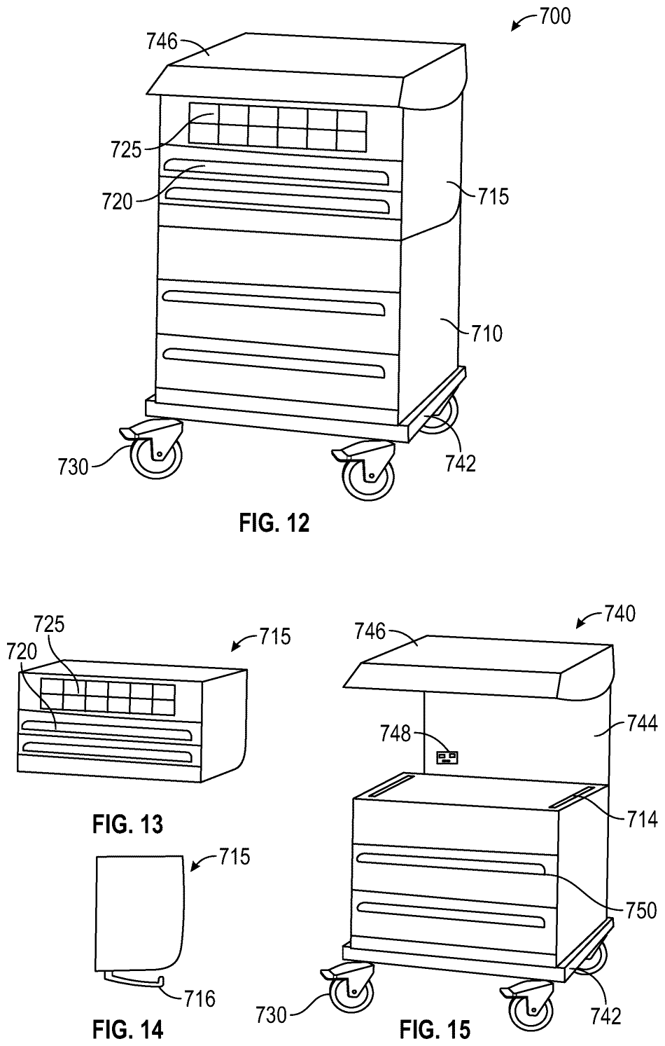

According to aspects of the disclosure, a robotic automated dispensing system 700 is shown in FIGS. 12 to 15. Robotic automated dispensing system 700 may be configured for robotic movement of only a removable section 715 of a dispensing cabinet 710 to and from a pharmacy. For example, robotic automated dispensing system 700 may be an anesthesia station, where the removable section 715 travels between an operating suite and a pharmacy of a medical center (e.g., hospital, outpatient surgical clinic) via a robotic device (e.g., robotic delivery device 300) so that the robotic automated dispensing system 700 is properly stocked for upcoming surgical procedures.

The robotic automated dispensing system 700 may include the removable section 715 of the dispensing cabinet 710 with multiple securable drawers 720 and/or compartments 725. A mobile shell may include a base 742, a back wall 744, a top surface 746, a connection point 748 (e.g., for power and/or data) and movement elements 730 (e.g., wheels). The mobile shell 740 may also include additional storage elements 750 (e.g., drawers).

Movement elements 730 (e.g., wheels) allow for the robotic automated dispensing system 700 to be moved around and/or positioned by hand. For example, the robotic automated dispensing system 700 may be pushed by a nurse in close to an anesthesiologist positioned by a patient on an operating table during a surgery and then pushed to a docking position along a wall after the anesthesiologist role in the surgery is done. Here, the movement elements 730 are un-powered wheels that can be freely moved by pushing or pulling the robotic automated dispensing system 700. In aspects of the disclosure, at least one of the movement elements 730 may be lockable or securable in order to hold the robotic automated dispensing system 700 in position.

In use, the robotic automated dispensing system 700 shown in FIG. 12 may be engaged by a robotic delivery device 300, which may remove and transport the removable section 715 of the dispensing cabinet 710 to the pharmacy to be restocked, leaving the mobile shell 740 in position in the original location (e.g., operating suite). Once the removable section 715 is restocked by the pharmacy, the same or different robotic delivery device 300 may retrieve the restocked removable section 715 and return it to the mobile shell 740 that it was removed from, or to a different mobile shell 740, for example.

For example, the robotic delivery device 300 may scan a barcode or other identifying information, which may be located in the connection point 748 of the mobile shell 740 to identify the mobile shell 740 intended to receive the removable section 715. The robotic delivery device 300 may then insert the removable section 715 into the mobile shell 740, where skids 716 on the removable section 715 mate with recesses 714 on the dispensing cabinet 710. Also, a power/communications connection may be established between the removable section 715 (e.g., a connection port) and the connection point 748.

In aspects of the disclosure, any suitable mounting and/or guide structures (e.g., rails, latches, other connective structure) may be provided on the removable section 715, the dispensing cabinet 710 and the mobile shell 740. In aspects of the disclosure, barcodes or other identifying information may be disposed on the removable section 715, the dispensing cabinet 710, individual drawers 720 and compartments 725 and/or any location of the mobile shell 740. In aspects of the disclosure, the robotic automated dispensing system 700 may include a self-moving device (e.g., drive unit 460 and self-movement elements 470), allowing the robotic automated dispensing system 700 to be self-driven as well.

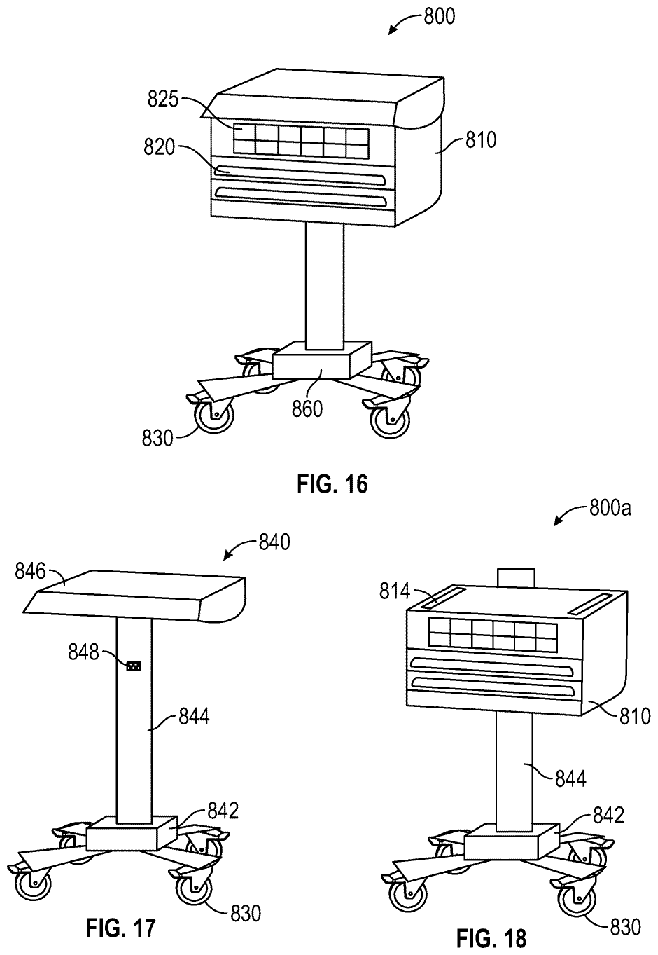

According to aspects of the disclosure, a robotic automated dispensing system 800 is shown in FIGS. 16 to 18. As shown in FIG. 16, robotic automated dispensing system 800 may be configured as a lighter weight/size version of robotic automated dispensing system 400 and may be similarly configured for robotic movement of the entire system to and from a pharmacy. For example, robotic automated dispensing system 800 may be an anesthesia station that travels between an operating suite and a pharmacy of a medical center (e.g., hospital, outpatient surgical clinic) so that the robotic automated dispensing system 800 is properly stocked for upcoming surgical procedures.

The robotic automated dispensing system 800 may include a mobile dispensing cabinet 810 with multiple securable drawers 820 and/or compartments 825. Movement elements 830 (e.g., wheels) allow for the robotic automated dispensing system 800 to be moved around and/or positioned by hand as described above.

A drive unit 860 and self-movement elements (e.g., motorized wheels 470) provide self-movement functions to the robotic automated dispensing system 800. For example, the drive unit 860 may include any of a motor or drive linked to the self-movement elements 470, a steering mechanism for controlling the direction of movement, and one or more location tracking devices (e.g., sensors or geolocation devices) to identify the current position of the robotic automated dispensing system 800 and to guide the robotic automated dispensing system 800 to a desired destination (e.g., surgical suite, pharmacy). In some implementations, the location tracking device may transmit information identifying a current location of the associated cabinet. The drive unit 860 may also include docking connectors (e.g., power connector, communication connector), as well as an energy storage device (e.g., a battery).

In aspects of the disclosure, the movement elements 830 may be movable by hand in a disengaged or non-powered state, while the movement elements 830 may be configured as the self-movement elements in an engaged or powered state. For example, in the disengaged state, the movement elements 830 may be disengaged or unlinked from the drive unit 860, whereas in the engaged state the movement elements 830 may be engaged by or linked to the drive unit 860. Thus, the movement elements 830 may be used for both hand movement/positioning and self-movement/driving of the robotic automated dispensing system 800.

In aspects of the disclosure, as shown in FIGS. 17 and 18, robotic automated dispensing system 800a may be configured as a lighter weight/size version of robotic automated dispensing system 500 and may be similarly configured for robotic movement of only a removable dispensing cabinet 810 to and from a pharmacy. For example, robotic automated dispensing system 800a may be an anesthesia station, where the removable dispensing cabinet 810 travels between an operating suite and a pharmacy of a medical center (e.g., hospital, outpatient surgical clinic) via a robotic device (e.g., robotic delivery device 300) so that the robotic automated dispensing system 800a is properly stocked for upcoming surgical procedures.

The robotic automated dispensing system 800a may include the removable dispensing cabinet 810 with multiple securable drawers 820 and/or compartments 825. A mobile shell 840 may include a base 842, a back wall 844, a top surface 846, a connection point 848 (e.g., for power and/or data) and movement elements 830 (e.g., wheels). In use, the robotic automated dispensing system 800a shown in FIGS. 17 and 18 may be engaged by a robotic delivery device 300, which may remove and transport the removable dispensing cabinet 810 to the pharmacy to be restocked, leaving the mobile shell 840 in position in the original location (e.g., operating suite). Once the removable dispensing cabinet 810 is restocked by the pharmacy, the same or different robotic delivery device 300 may retrieve the restocked removable dispensing cabinet 810 and return it to the mobile shell 840 that it was removed from, or to a different mobile shell 840, for example.

For example, the robotic delivery device 300 may scan a barcode or other identifying information, which may be located in the connection point 848 of the mobile shell 840 to identify the mobile shell 840 intended to receive the removable dispensing cabinet 810. The robotic delivery device 300 may then insert the removable dispensing cabinet 810 into the mobile shell 840 and skids on the on the underside of the top surface may mate with recesses 814 on the dispensing cabinet 810. Also, a power/communications connection may be established between the removable dispensing cabinet 810 (e.g., a connection port on the cabinet) and the connection point 848.

In aspects of the disclosure, any suitable mounting and/or guide structures (e.g., recesses, skids, rails, latches, other connective structure) may be provided on the removable dispensing cabinet 810 and the mobile shell 840. In aspects of the disclosure, barcodes or other identifying information may be disposed on the removable dispensing cabinet 810, individual drawers 820 and compartments 825 and/or any location of the mobile shell 840.

In aspects of the disclosure, any of the above described features may be used in any of the systems described above (e.g., automated dispensing systems 100, 200, 400-800 or robotic delivery device 300).

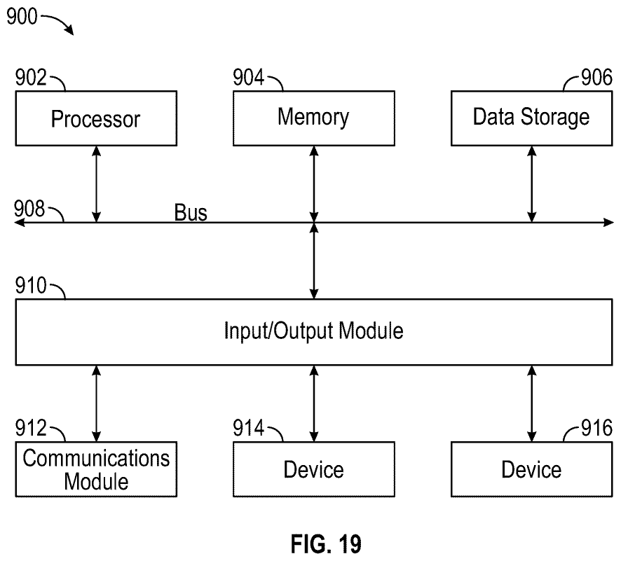

FIG. 19 is a block diagram illustrating an example computer system 900 with which the robotic automated dispensing cabinet or robotic delivery device of FIGS. 3-18 can be implemented. In certain aspects, the computer system 900 may be implemented using hardware or a combination of software and hardware, either in a dedicated server, or integrated into another entity, or distributed across multiple entities.

Computer system 900 (e.g., an automated medical dispensing system) includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PUP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Example input/output modules 910 include data ports such as USB ports. The input/output module 910 is configured to connect to a communications module 912. Example communications modules 912 include networking interface cards, such as Ethernet cards and modems. In certain aspects, the input/output module 910 is configured to connect to a plurality of devices, such as an input device 914 and/or an output device 916. Example input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 916 include display devices, such as a LED (light emitting diode), CRT (cathode ray tube), or LCD (liquid crystal display) screen, for displaying information to the user.

According to one aspect of the present disclosure, the inventory management system can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 902 for execution. Such a medium may take many forms, including, but not limited to, non-volatile media, volatile media, and transmission media. Non-volatile media include, for example, optical disks, magnetic disks, or flash memory, such as data storage device 906. Volatile media include dynamic memory, such as memory 904. Transmission media include coaxial cables, copper wire, and fiber optics, including the wires that comprise bus 908. Common forms of computer-readable media or machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

It is understood that any specific order or hierarchy of blocks in the methods of processes disclosed is an illustration of example approaches. Based upon design or implementation preferences, it is understood that the specific order or hierarchy of blocks in the processes may be rearranged, or that all illustrated blocks be performed. In some implementations, any of the blocks may be performed simultaneously.

In one or more embodiments, a robotic automated dispensing system comprises a dispensing cabinet, a location tracking device configured to transmit information identifying a current location of the dispensing cabinet, a drive unit, and one or more movement elements in dynamic connection with the drive unit, wherein in a first mode, at least one of the one or more movement elements is engaged to move via a first force provided by the drive unit, and wherein in a second mode, at least one of the one or more movement elements is disengaged from the drive unit to move via a second force.

In aspects of the disclosure, the at least one disengaged movement element comprises a plurality of unpowered wheels coupled to the dispensing cabinet, the plurality of unpowered wheels configured to move the dispensing cabinet via the second force that comprises an external force applied to the dispensing cabinet. In aspects of the disclosure, the at least one engaged movement element comprises at least one self-movement element coupled to the dispensing cabinet and to the drive unit, the at least one self-movement element comprising one of a wheel and a track. In aspects of the disclosure, the at least one self-movement element is moveably coupled to the dispensing cabinet, the self-movement element configured to be disposed in a first position engaged with a floor during application of the first force from the drive unit and to be disposed in a second position disengaged from the floor during application of the second force. In aspects of the disclosure, the at least one self-movement element is releasably coupled to the drive unit and engaged with a floor, the self-movement element configured to be coupled with the drive unit during application of the first force from the drive unit and to be uncoupled from the drive unit during application of the second force. In aspects of the disclosure, the dispensing cabinet comprises at least one of a securable drawer and a securable compartment.

In one or more embodiments, a mobile automated dispensing system comprises a dispensing cabinet including a removable section, the removable section adapted to securely contain a medical item, a mobile shell attached to the dispensing cabinet and adapted to move the dispensing cabinet, and a location tracking device configured to transmit information identifying a current location of the dispensing cabinet.

In aspects of the disclosure, the mobile shell comprises a base; a back wall; a top surface; a connection point; and one or more movement elements. In aspects of the disclosure, the one or more movement elements comprises a plurality of unpowered wheels coupled to the dispensing cabinet, the plurality of unpowered wheels configured to move the dispensing cabinet via an external force applied to the dispensing cabinet. In aspects of the disclosure, the mobile shell comprises a drive unit, and wherein the one or more movement elements comprises at least one self-movement element coupled to the dispensing cabinet and to the drive unit, the at least one self-movement element comprising one of a wheel and a track. In aspects of the disclosure, the entire dispensing cabinet is the removable section that is releasably coupled to the mobile shell, the dispensing cabinet comprising a connection port configured to mate with the connection point of the mobile shell to provide one of power and data communications to the dispensing cabinet. In aspects of the disclosure, the removable section comprises a skid disposed on a bottom of a top surface of the mobile shell, the skid configured to mate with a recess disposed on a top surface of the dispensing cabinet. In aspects of the disclosure, the dispensing cabinet comprises a fixed section fixedly coupled to the mobile shell and the removable section releasably coupled to the mobile shell, the removable section comprising a connection port configured to mate with the connection point of the mobile shell to provide one of power and data communications to the removable section. In aspects of the disclosure, the removable section comprises a skid disposed on a bottom surface, the skid configured to mate with a recess disposed on a top surface of the fixed section.

In one or more embodiments, a robotic delivery device comprises a transport bed adapted to engage with a removable section of a dispensing cabinet, a drive unit, one or more movement elements in connection with the drive unit, and a processor. The processor is configured to receive cabinet location information for the dispensing cabinet, said cabinet location information identifying a current location of the dispensing cabinet, determine device location information identifying a current location of the robotic delivery device, and activate the drive unit to move the robotic delivery device toward the dispensing cabinet, said activation based at least in part on the device location information and the device location information.

In aspects of the disclosure, the robotic delivery device comprises a key configured to unlock the removable section of the dispensing cabinet for removal from the dispensing cabinet. In aspects of the disclosure, the removable section of the dispensing cabinet is configured to have at least one of a plurality of states comprising a use state indicating an identification of an automated dispensing system in which the removable section is disposed, an in-transit state indicating an identification of the robotic delivery device that is transporting the removable section, a refill state indicating a location of the removable section while it is awaiting refill, a being refilled state, a filled and awaiting checking state, and a filled and checked state. In aspects of the disclosure, the removable section is configured to be stored to prohibit opening of the removable section when in the refill state. In aspects of the disclosure, the removable section is configured to one of identify the person refilling the movable section when in the being refilled state and identify the person who checked the movable section when in the filled and checked state. In aspects of the disclosure, the removable section of the dispensing cabinet is configured to be coupled to a docking station when in the being refilled state, the docking station configured to permit access to the contents of the removable section.

The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The word “exemplary” is used herein to mean “serving as an example or illustration.” Any aspect or design described herein as “exemplary” is not necessarily to be construed as preferred or advantageous over other aspects or designs. In one aspect, various alternative configurations and operations described herein may be considered to be at least equivalent.

As used herein, the phrase “at least one of” preceding a series of items, with the term “or” to separate any of the items, modifies the list as a whole, rather than each item of the list. The phrase “at least one of” does not require selection of at least one item; rather, the phrase allows a meaning that includes at least one of any one of the items, and/or at least one of any combination of the items, and/or at least one of each of the items. By way of example, the phrase “at least one of A, B, or C” may refer to: only A, only B, or only C; or any combination of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

As used herein, the terms “provide” or “providing” encompass a wide variety of actions. For example, “providing” may include storing a value in a location of a storage device for subsequent retrieval, transmitting a value directly to the recipient via at least one wired or wireless communication medium, transmitting or storing a reference to a value, and the like. “Providing” may also include encoding, decoding, encrypting, decrypting, validating, verifying, inserting and the like via a hardware element.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain.

It is understood that the specific order or hierarchy of steps, operations or processes disclosed is an illustration of exemplary approaches. Based upon design preferences, it is understood that the specific order or hierarchy of steps, operations or processes may be rearranged. Some of the steps, operations or processes may be performed simultaneously. Some or all of the steps, operations, or processes may be performed automatically, without the intervention of a user. The accompanying method claims, if any, present elements of the various steps, operations or processes in a sample order, and are not meant to be limited to the specific order or hierarchy presented.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.” Furthermore, to the extent that the term “include,” “have,” or the like is used, such term is intended to be inclusive in a manner similar to the term “comprise” as “comprise” is interpreted when employed as a transitional word in a claim.

In any embodiment, data can be forwarded to a “remote” device or location,” where “remote,” means a location or device other than the location or device at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

Some embodiments include implementation on a single computer, or across a network of computers, or across networks of networks of computers, for example, across a network cloud, across a local area network, on hand-held computer devices, etc. The computers may be physical machines or virtual machines hosted by other computers. In certain embodiments, one or more of the steps described herein are implemented on a computer program(s). Such computer programs execute one or more of the steps described herein. In some embodiments, implementations of the subject method include various data structures, categories, and modifiers described herein, encoded on computer-readable medium(s) and transmissible over communications network(s).

Software, web, internet, cloud, or other storage and computer network implementations of the present invention could be accomplished with standardized programming techniques specifically adapted to cause one or more device to perform the various assigning, calculating, identifying, scoring, accessing, generating or discarding steps described.

The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way.

What is claimed is:

1. A robotic automated dispensing system, comprising:
a dispensing cabinet;
a location tracking device configured to transmit information identifying a current location of the dispensing cabinet;
a drive unit; and
one or more movement elements in dynamic connection with the drive unit, wherein in a first mode, at least one of the one or more movement elements is engaged to move via a first force provided by the drive unit, and wherein in a second mode, at least one of the one or more movement elements is disengaged from the drive unit to move via a second force.

2. The robotic automated dispensing system of claim 1, wherein the at least one disengaged movement element comprises a plurality of unpowered wheels coupled to the dispensing cabinet, the plurality of unpowered wheels configured to move the dispensing cabinet via the second force that comprises an external force applied to the dispensing cabinet.

3. The robotic automated dispensing system of claim 1, wherein the at least one engaged movement element comprises at least one self-movement element coupled to the dispensing cabinet and to the drive unit, the at least one self-movement element comprising one of a wheel and a track.

4. The robotic automated dispensing system of claim 3, wherein the at least one self-movement element is moveably coupled to the dispensing cabinet, the self-movement element configured to be disposed in a first position engaged with a floor during application of the first force from the drive unit and to be disposed in a second position disengaged from the floor during application of the second force.

5. The robotic automated dispensing system of claim 3, wherein the at least one self-movement element is releasably coupled to the drive unit and engaged with a floor, the self-movement element configured to be coupled with the drive unit during application of the first force from the drive unit and to be uncoupled from the drive unit during application of the second force.

6. The robotic automated dispensing system of claim 1, wherein the dispensing cabinet comprises at least one of a securable drawer and a securable compartment.

7. A mobile automated dispensing system, comprising:
a dispensing cabinet including a removable section, the removable section adapted to securely contain a medical item;
a mobile shell attached to the dispensing cabinet and adapted to move the dispensing cabinet; and
a location tracking device configured to transmit information identifying a current location of the dispensing cabinet.

8. The mobile automated dispensing system of claim 7, wherein the mobile shell comprises:
a base;
a back wall;
a top surface;
a connection point; and
one or more movement elements.

9. The mobile automated dispensing system of claim 8, wherein the one or more movement elements comprises a plurality of unpowered wheels coupled to the dispensing cabinet, the plurality of unpowered wheels configured to move the dispensing cabinet via an external force applied to the dispensing cabinet.

10. The mobile automated dispensing system of claim 8, wherein the mobile shell comprises a drive unit, and wherein the one or more movement elements comprises at least one self-movement element coupled to the dispensing cabinet and to the drive unit, the at least one self-movement element comprising one of a wheel and a track.

11. The mobile automated dispensing system of claim 8, wherein the entire dispensing cabinet is the removable section that is releasably coupled to the mobile shell, the dispensing cabinet comprising a connection port configured to mate with the connection point of the mobile shell to provide one of power and data communications to the dispensing cabinet.

12. The mobile automated dispensing system of claim 11, wherein the removable section comprises a skid disposed on a bottom of a top surface of the mobile shell, the skid configured to mate with a recess disposed on a top surface of the dispensing cabinet.

13. The mobile automated dispensing system of claim 8, wherein the dispensing cabinet comprises:
a fixed section fixedly coupled to the mobile shell; and
the removable section releasably coupled to the mobile shell, the removable section comprising a connection port configured to mate with the connection point of the mobile shell to provide one of power and data communications to the removable section.

14. The mobile automated dispensing system of claim 13, wherein the removable section comprises a skid disposed on a bottom surface, the skid configured to mate with a recess disposed on a top surface of the fixed section.

15. A robotic delivery device, comprising:
a transport bed adapted to engage with a removable section of a dispensing cabinet;
a drive unit;
one or more movement elements in connection with the drive unit; and
a processor configured to:
receive cabinet location information for the dispensing cabinet, said cabinet location information identifying a current location of the dispensing cabinet;
determine device location information identifying a current location of the robotic delivery device; and
activate the drive unit to move the robotic delivery device toward the dispensing cabinet, said activation based at least in part on the device location information and the device location information.

16. The robotic delivery device of claim 15, further comprising a key configured to unlock the removable section of the dispensing cabinet for removal from the dispensing cabinet.

17. The robotic delivery device of claim 15, wherein the removable section of the dispensing cabinet is configured to have at least one of a plurality of states comprising:
a use state indicating an identification of an automated dispensing system in which the removable section is disposed;
an in-transit state indicating an identification of the robotic delivery device that is transporting the removable section;
a refill state indicating a location of the removable section while it is awaiting refill;
a being refilled state;
a filled and awaiting checking state; and
a filled and checked state.

18. The robotic delivery device of claim 17, wherein the removable section is configured to be stored to prohibit opening of the removable section when in the refill state.

19. The robotic delivery device of claim 17, wherein the removable section is configured to one of:
identify the person refilling the movable section when in the being refilled state; and
identify the person who checked the movable section when in the filled and checked state.

20. The robotic delivery device of claim 17, wherein the removable section of the dispensing cabinet is configured to be coupled to a docking station when in the being refilled state, the docking station configured to permit access to the contents of the removable section.
